(19) United States
(12) Patent Application Publication
(10) Pub. No.: US 2002/0146362 A1
(43) Pub. Date: Oct. 10, 2002

(54) Method of filtration and cleansing of high temperature combustible gases

(76) Inventors: Kevin Mcquigg, Broken Arrow, OK (US); W. N. Scott, Tulsa, OK (US); Don Mellott, Catoosa, OK (US); Bruce N. Stevens, Tulsa, OK (US)

Correspondence Address: MOLLY D MCKAY, PC, 3207 E 22ND STREET, TULSA, OK, 74114-1823, US

(21) Appl. No.: 09/828,735

(22) Filed: Apr. 9, 2001

(51) Int. Cl. B01D 53/34

(52) U.S. Cl. 423/215.5; 423/243.08

(57) ABSTRACT

A method for filtering and cleaning high temperature combustible gases, such as synthetic gas produced by a gasifier. The method involves introducing reactive lime to the hot combustible gas that has been previously cooled to less than approximately thirteen hundred (1,300) degrees Fahrenheit, and then filtering the gas through ceramic fiber filters to remove any particulate matter and the calcium salts resulting from the reaction of the lime with the chemical pollutants present within the gas. Optionally, reactive lime may also be introduced into the biomass feed as it travels to the gasifier.

### BACKGROUND OF THE INVENTION

1. Field of the Invention

The present invention relates to a method of filtering and cleaning high temperature combustible gases. Specifically, the present invention has been used to clean and filter high temperature combustible gases produced in a gasification process prior to those gases being combusted. The present invention involves adding reactive lime to the gases under controlled temperature to react with the pollutants and subsequently filtering the pollutants and particulate matter from the gases employing ceramic fiber filters.

2. Description of the Related Art

It is believed that use of ceramic fiber filters has been limited to post combustion cleaning and filtration of gases created from incineration. Most of this work has been conducted in the European market in compliance with the air quality restrictions of Germany's TA Luft and other regulatory agencies. Since the use of this type of filtration system was in post-combustion operation, short pulses of compressed air accomplished the pulse jet cleaning of the filters.

In the United States, filtration of synthesis gases from the gasification of solids, such as coal or gas, has been accomplished with silicon carbide filters. This type of filter has several undesirable qualities, including high-pressure drop across the filtration medium, low resistance to thermal shock, and high cost.

The present invention employs ceramic fiber filters as a continuous filtration and method of removal of potential chemical pollutants from combustible gases at temperatures in excess of one thousand (1,000) degrees Fahrenheit. These potential chemical pollutants may include, but not limited to, sulfur, chlorine, phosphorus, etc. Reactive lime, also known as calcium carbonate, is injected in the inlet to the filter housing to react with and capture the chemical pollutants. Although lime injection has been known as an effective method for pollutant removal, the application of this technology has been limited to post combustion applications, such as for example sulfur removal from coal fired utility boilers. A second point of introduction of lime may include blending all or a portion of the required lime into the solids feeding systems for the gasification reactor.

Despite current teaching that the synthesis gas stream exiting the gasifier should retain as much of its heat and temperature as possible, the current invention must reduce the temperature of the resulting synthesis gas stream. For the chemical pollutants to reaction effectively and efficiently with the lime, the temperature of the synthesis gas at the entrance to the filters prior to the lime being injected into the gas stream must be controlled to a temperature less than approximately thirteen hundred (1,300) degrees Fahrenheit. The temperature may be controlled either by direct contact cooling, e.g. by injecting water into the gas stream, or by indirect cooling, e.g. by use of a heat exchanger that transfers heat from the gas stream to ambient air. For temperatures below one thousand (1,000) degrees Fahrenheit, an additional conditioning chamber is required for sufficient residence time to lower the gas stream to the desired temperature.

After the lime has reacted with the chemical pollutants, the newly formed dry compounds, e.g. calcium sulfate, calcium phosphate, calcium chloride, etc., are captured on the surface of the ceramic filters. In addition to capturing the dry reacted compounds, the filters also capture any entrained particulate matter, such as soot particles, unreacted lime, etc. The accumulation of these dry compounds and entrained particulate matter on the filters will ultimately foul the filters.

As the pressure drop across the filters increases due to fouling, a pulse of gas is directed to the filter to effectively shake and blow the filter clean. The discharged solids collected on the filter fall to the bottom of the filter housing where they gravity flow through a rotary air lock and are then mechanically conveyed to an ash storage location. Historically, the motive gas for pulsing has been air. Employing air in this process is not desirable since the oxygen in the air will cause an ignition of the hot, combustible gases that are being cleansed. To eliminate the possibility of spontaneous combustion of the gases, an oxygen free gas, such as for example nitrogen, carbon dioxide, synthesis gas, or natural gas, may be employed. A preferred approach when cleaning gases evolved from the gasification of biomass or coal is to use combustible gases, such as methane, propane, or natural gas, as the pulsing media. By using combustible gas as the pulsing media, the evolved synthesis gases are not diluted.

One objective of this invention is that the hot gases are purified to a cleanliness specification equal to that of natural gas. A further objective of the invention is to use flexible ceramic filters to decrease incipient pressure drop and increase resistance to thermal shock. Still a further objective of the present invention is to produce an easily handled, dry solid composed of calcium salts and particulate matter as the discharge from the cleansing operation. Another objective of the invention is to proactively remove chemical pollutants from the gas stream while the pollutants are reactive and before they have formed air pollutants such as oxides of sulfur, phosphorus, chlorine, etc., as would occur in post combustion removal. A final objective of the present invention is providing a filtration system that is continuously operated while the combustible, cleansed gases are not diluted by inert pulse gases.

### SUMMARY OF THE INVENTION

The present invention is a method for filtering and cleaning high temperature combustible gases, such as those produced by a gasifier. The method involves introducing reactive lime to the heated gas stream that has been cooled to less than approximately thirteen hundred (1,300) degrees Fahrenheit, then filtering the gas through ceramic fiber filters. Alternately, reactive lime may also be introduced into the biomass feed as it travels to the gasifier.

### BRIEF DESCRIPTION OF THE DRAWINGS

FIG. 1 is a flow diagram showing the steps and equipment employed in practicing the present invention.

### DETAILED DESCRIPTION OF THE PREFERRED EMBODIMENT

### The Invention

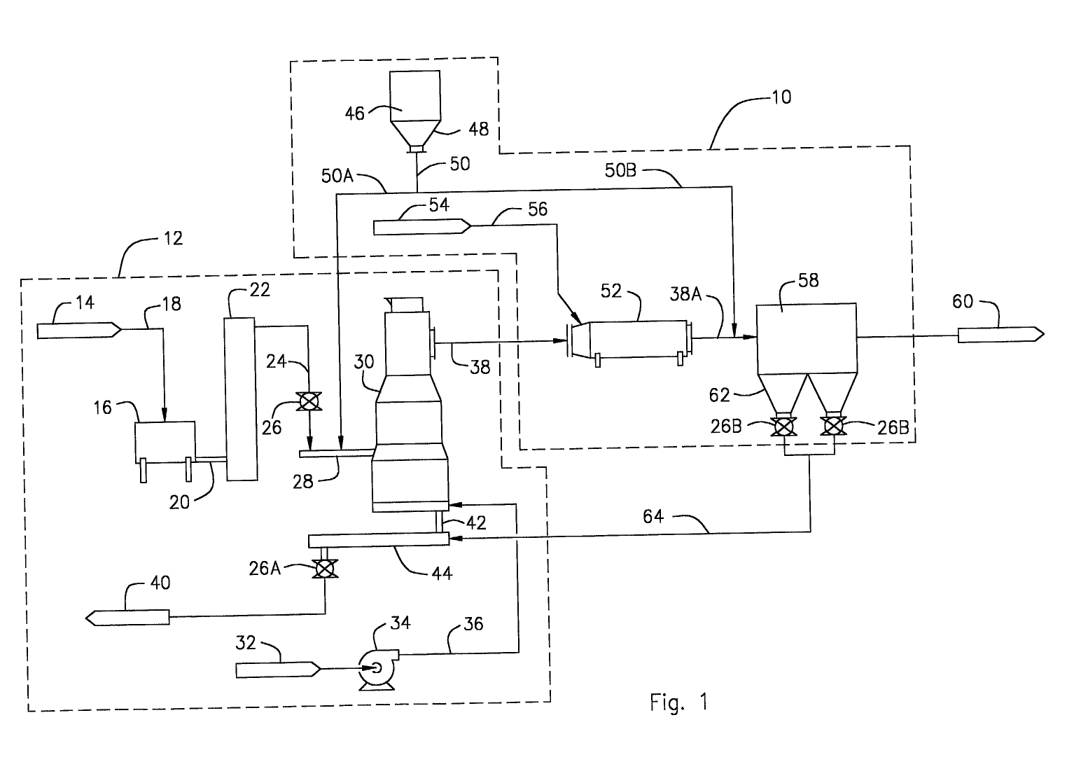

Referring now to FIG. 1, there is illustrated a flow diagram of the steps and equipment involved in practicing a preferred embodiment of the present invention. The invention is a method for filtering and cleaning high temperature combustible gases, such as those produced by a gasifier. FIG. 1 shows the method as it would be employed in association with a biomass gasifying process. Locally available forms of biomass might include rice straw or rice hulls, sugar cane bagasse, poultry litter, refuse, paper plant pulp sludge, switchgrass, waste resulting from extraction of olive oil from olives, peanut shells, sawdust or wood chips, wood bark, municipal solid waste, coconut shells, corn cobs, cotton stover, coal, etc.

Referring to FIG. 1, box 10 shows the steps and equipment involved in practicing the invention and box 12 shows steps and equipment involved in the normal gasification process. The normal gasification process 12 will be discussed first, and then the invention, as represented by box 10, will be discussed in association with the gasification process 12.

Beginning at the far left-hand side of FIG. 1, the biomass feed is represented by numeral 14. The biomass feed 14 is conveyed to a metering bin 16, as indicated by line 18. The appropriate feed rate of biomass feed 14 is metered out by the metering bin 16 and transferred, as indicted by line 20, to a bucket elevator 22. The metered feed rate of biomass feed 14 travels, as indicated by line 24, from the bucket elevator 22, through an air lock 26, to an infeed conveyor 28. The infeed conveyor 28 conveys the metered feed rate of biomass feed 14 into the gasifier 30.

Also, as shown by line 36 at the bottom of FIG. 1, the gasifier 30 receives a restricted amount of air, i.e. underfire air 32, that is provided by an underfire air fan 34. The underfire air 32 is an amount of air insufficient for complete combustion of the biomass feed 14 entering the gasifier 30.

The gasifier 30 heats the biomass feed 14 in the presence of underfire air 32 to produce a hot combustible gas stream, as indicated by line 38. Bottom ash 40 from the gasifier 30 drops out of the bottom of the gasifier 30, as indicated by line 42, onto an ash conveyor 44. The ash conveyer 44 conveys the bottom ash through another air lock 26A before the bottom ash 40 is disposed.

The invention 10 will now be described in relationship to the previously described normal gasification process 12. Referring now to top of FIG. 1, reactive lime 46 is fed from a lime silo 46 via a common lime feed line 50 to lime feed lines 50A and 50B. The first lime feed line 50A conveys reactive lime 46 to the infeed conveyor 28 where the active lime 46 is available to react with chemical pollutants contained in the biomass feed 14 as the biomass feed 14 is processed in the gasifier 30.

Generally, the amount of reactive lime 46 conveyed by the first lime feed line 50A is of a stoichiometric amount plus between 20 and 30 percent excess of the stoichiometric amount. The stoichiometric amount is the precise amount of lime need to fully react with the previously determined concentration of chemical pollutants contained within biomass feed 14 at the feed rate under which the gasifier 30 is operating. However, it may be desirable to eliminate line 50A or greatly reduce the amount of lime 46 fed to the infeed conveyor via line 50A, depending on the type of biomass feed 14 involved.

The hot combustible gas stream 38 exits the gasifier 30 and enters a conditioning chamber 52. The temperature of the hot combustible gas stream 38 as it exits the gasifier 30 is in the approximately fifteen hundred (1,500) to sixteen hundred (1,600) degrees Fahrenheit. The purpose of passing the hot combustible gas stream 38 through the conditioning chamber 52 is to cool the hot combustible gas stream 38, via a quench medium 54 that is supplied to the conditioning chamber 52 by line 56. The quench medium 54 will vary depending on whether the temperature of the hot combustible gas stream 38 is cooled by direct contact cooling, in which case the quench medium 54 might be water injected into the hot combustible gas stream 38 within the conditioning chamber 52, or by indirect cooling, in which case the quench medium 54 might be water or ambient air flowing through the conditioning chamber which serves as a heat exchanger for transferring heat from the hot combustible gas stream to the cooler quench medium 54. The temperature of the hot combustible gas stream 38A as it leaves the conditioning chamber 52 should be below approximately thirteen hundred (1,300) degrees Fahrenheit. If the temperature of the hot combustible gas stream 38A exiting the conditioning chamber 52 is desired to be below one thousand (1,000) degrees Fahrenheit, an additional conditioning chamber (not illustrated) may be required in series with the first conditioning chamber 52. A second conditioning chamber (not illustrated) would be required to provide sufficient residence time to lower the entering hot combustible gas stream 38 to the desired exit temperature.

The reactive lime 46 is supplied to the hot combustible gas stream 38A from the lime silo 48 via the second lime feed line 50B in an amount in excess of stoichiometric need based on the amount of chemical pollutants remaining in the hot combustible gas stream 38A. It is important that the temperature of the hot combustible gas stream 38A leaving the conditioning chamber 52 is at a temperature less than approximately thirteen hundred (1,300) degrees Fahrenheit. If the temperature of the hot combustible gas stream 38A is above approximately thirteen hundred (1,300) degrees Fahrenheit, then the reactive lime 46 will not react properly with the chemical pollutants to form a calcium compound that can subsequently be filtered from the hot combustible gas stream 38A, along with any remaining entrained particulate matter, by a plurality of the ceramic fiber filters 58 that are located within a filter bag house to produce a clean synthetic gas or syngas 60. The optimum temperature for this method appears to be around one thousand one hundred and fifty (1,150) degrees Fahrenheit, with efficiency decreasing as temperatures exceed one thousand two hundred and fifty (1,250) degrees Fahrenheit. Temperatures in excess of approximately thirteen hundred (1,300) degrees Fahrenheit produce unacceptable reaction efficiencies. There is essentially no reaction between the lime 46 and the chemical pollutants when the temperature exceeds fourteen hundred (1,400) degrees Fahrenheit.

It is not fully understood exactly why the reactive lime 46 does not react with the chemical pollutants when the hot combustible gas stream 38A exceeds approximately thirteen hundred degrees Fahrenheit, but it may have to do with the disassociation on the lime at these temperatures.

The calcium compounds and the particulate matter that are retained on the outside surfaces of the tubes of ceramic fiber filters 58 are blown off of the filters 58 by short pulses of gas blown countercurrent through the filters 58. It is important that the gas employed in this pulse cleaning of the filters 58 not be air and not contain oxygen since use of these types of gases would result in spontaneous combustion. To eliminate the possibility of spontaneous combustion of the gases, an oxygen free gas, such as for example nitrogen, carbon dioxide, synthesis gas, or natural gas, may be employed. A preferred approach when cleaning gases evolved from the gasification of biomass or coal is to use combustible gases, such as methane, propane, or natural gas, as the pulsing media. By using combustible gas as the pulsing media, the evolved synthesis gases 60 are not diluted.

The dry waste material that results from the pulse cleaning of the filters 58 falls via gravity down to the bottom of the filter bag house 62 where it leaves the filter bag house 62 via one or more dry waste air locks 26B. From the filter bag house 62, the dry waste material travels via line 64 to the ash conveyer 44. The ash conveyor disposes of the dry waste material along with the bottom ash 40, as has been previously described.

The flexible ceramic fiber filters are commercially available from a variety of sources. One such source in the United Kingdom is Ceramic Filtration (International) Ltd., Brinkworth House, Brinkworth, Wiltshire SN15 5DF. Another source in the United States is Griffin Environmental Company, Inc., 7066 Interstate Island Rd., Syracuse, N.Y. 13209.

While the invention has been described with a certain degree of particularity, it is manifest that many changes may be made in the details of construction and the arrangement of components without departing from the spirit and scope of this disclosure. It is understood that the invention is not limited to the embodiments set forth herein for the purposes of exemplification, but is to be limited only by the scope of the attached claim or claims, including the full range of equivalency to which each element thereof is entitled.

What is claimed is:

1. A method for filtering and cleansing high temperature combustible gases comprising the following steps:
a. reducing the temperature of a high temperature combustible gas stream to less than 1,300 degrees Fahrenheit,
b. adding lime to the gas stream so that the lime reacts with chemical pollutants in the gas stream,
c. filtering the gas stream through ceramic fiber filters to clean the gas stream of dry waste matter that consists of particulate matter and calcium salts resulting from the reaction between the lime and the chemical pollutants in the gas stream.

2. A method for filtering and cleansing high temperature combustible gases according to claim 1 further comprising:
d. periodically pulse cleaning the ceramic fiber filters to remove dry waste material from the filters.

3. A method for filtering and cleansing high temperature combustible gases according to claim 2 wherein the amount of lime added in step b is an amount in excess of a stoichiometric amount needed to react with all of the chemical pollutants contained within the gas stream.

4. A method for filtering and cleansing high temperature combustible gases according to claim 2 further comprising the following step that precedes step a:
e. adding lime to a biomass feed prior to the biomass feed entering a gasifier that generates the high temperature combustible gas stream of step a.

5. A method for filtering and cleansing high temperature combustible gases according to claim 4 wherein the amount of lime added in step e is an amount in excess of a stoichiometric amount needed to react with all of the chemical pollutants contained in the biomass feed.

6. A method for filtering and cleansing high temperature combustible gases according to claim 1 wherein the high temperature combustible gas stream is reduced to a temperature of less than 1,250 degrees Fahrenheit.

7. A method for filtering and cleansing high temperature combustible gases generated by a gasifier prior to the gases being combusted comprising the following steps:
a. receiving a high temperature combustible gas stream from a gasifier and reducing the temperature of the gas stream to less than 1,300 degrees Fahrenheit,
b. adding lime to the gas stream so that the lime reacts with chemical pollutants in the gas stream to form calcium salts,
c. filtering the gas stream through ceramic fiber filters to clean the gas stream of dry waste matter that consists of particulate matter and calcium salts resulting from the reaction between the lime and the chemical pollutants in the gas stream.

8. A method for filtering and cleansing high temperature combustible gases generated by a gasifier prior to the gases being combusted according to claim 7 further comprising:
d. periodically pulse cleaning the ceramic fiber filters with a non-oxidizing gas to remove dry waste material from the filters.

9. A method for filtering and cleansing high temperature combustible gases generated by a gasifier prior to the gases being combusted according to claim 8 wherein the amount of lime added in step b is an amount in excess of a stoichiometric amount needed to react with all of the chemical pollutants contained within the gas stream.

10. A method for filtering and cleansing high temperature combustible gases generated by a gasifier prior to the gases being combusted according to claim 8 further comprising the following step that precedes step a:
e. adding lime to a biomass feed prior to the biomass feed entering the gasifier that generates the high temperature combustible gas stream of step a.

11. A method for filtering and cleansing high temperature combustible gases generated by a gasifier prior to the gases being combusted according to claim 10 wherein the amount of lime added in step e is an amount in excess of a stoichiometric amount needed to react with all of the chemical pollutants contained in the biomass feed.

12. A method for filtering and cleansing high temperature combustible gases generated by a gasifier prior to the gases being combusted according to claim 7 wherein the high temperature combustible gas stream is reduced to a temperature of less than 1,250 degrees Fahrenheit.
